(19) United States
(12) Patent Application Publication
(10) Pub. No.: US 2007/0054567 A1
(43) Pub. Date: Mar. 8, 2007

(54) Assembled connecting device

(75) Inventor: Kuang-Hua Shiu, Hukou Township (TW)

Correspondence Address: TROXELL LAW OFFICE PLLC, 5205 LEESBURG PIKE, SUITE 1404, FALLS CHURCH, VA, 22041, US

(73) Assignee: Singatron Enterprise Co., Ltd.

(21) Appl. No.: 11/217,383

(22) Filed: Sep. 2, 2005

(51) Int. Cl. H01R 4/48

(52) U.S. Cl. 439/859

(57) ABSTRACT

An assembled connecting device according to the invention includes a containing space formed extendedly on one side of a connector and a plurality of pressing pieces configured extendedly on the other side of the connector. A corresponding base with a protruding pillar on one side joints the containing space of the connector by welding to achieve electrical conduction.

### BACKGROUND OF THE INVENTION

(a) Field of the Invention

The present invention relates to an assembled connecting device, and more particularly to an assembled connecting device characterized in that one side of a connector is extended to form a containing space.

(b) Description of the Prior Art

As shown in FIG. 1 and FIG. 2, a conventional connecting method is characterized in that an inner wire D1 of a conducting wire D and a protruding part A1 configured on a base A are joined by welding F to form a welded part C therebetween. During operation, pulling and dragging yet cause the conducting wire D to loosen or fall off.

In the view of the above, it is a vital task of the invention to overcome the technical difficulties and the aforesaid drawback of the prior art.

### SUMMARY OF THE INVENTION

The primary object of the invention is to provide an assembled connecting device comprising a containing space formed extendedly on one side of a connector and a plurality of pressing pieces configured on the other side thereof. A protruding pillar of a base is corresponded with the containing space of the assembled connecting device, and the two aforesaid parts are joined together by welding.

To better understand the invention, detailed descriptions of a preferred embodiment shall be given with the accompanying drawings below.

### BRIEF DESCRIPTION OF THE DRAWINGS

FIG. 1 shows an exploded elevational view of a conventional connector.

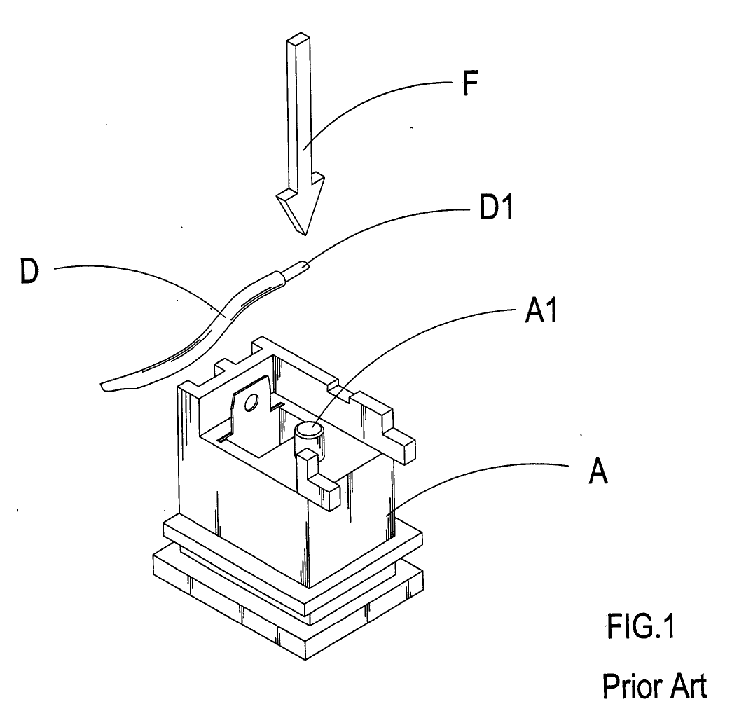

FIG. 2 shows an elevational view of a conventional connector.

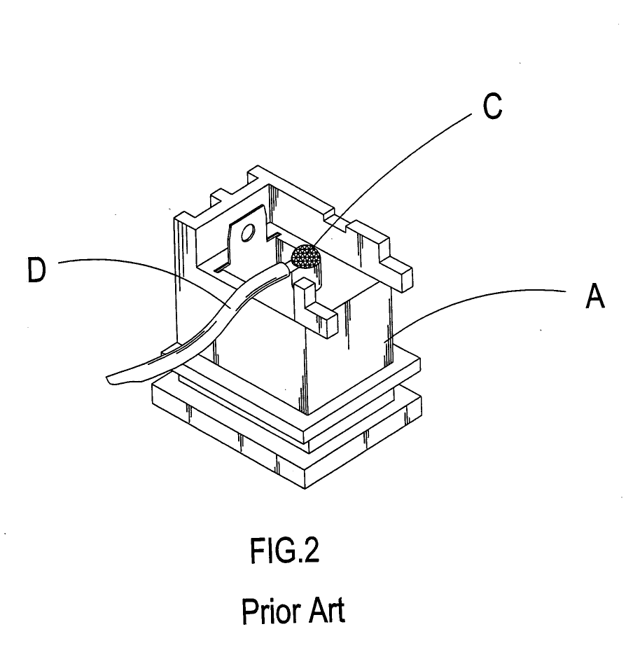

FIG. 3 shows an elevational view according to the invention.

FIG. 4 shows a first schematic view of the embodiment according to the invention.

FIG. 5 shows a second schematic view of the embodiment according to the invention.

FIG. 6 shows a third schematic view of the embodiment according to the invention.

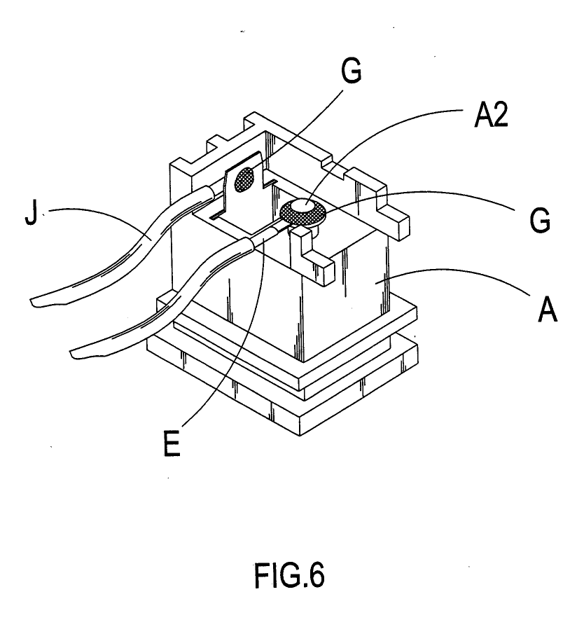

FIG. 7 shows a fourth schematic view of the embodiment according to the invention.

FIG. 8 shows a fifth schematic view of the embodiment according to the invention.

FIG. 9 shows a sixth schematic view of the embodiment according to the invention.

FIG. 10 shows a seventh schematic view of the embodiment according to the invention.

### DETAILED DESCRIPTION OF THE PREFERRED EMBODIMENTS

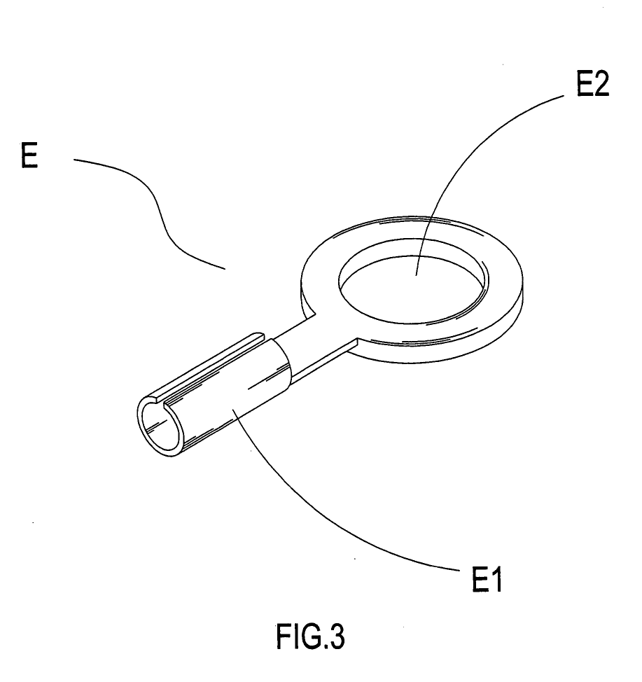

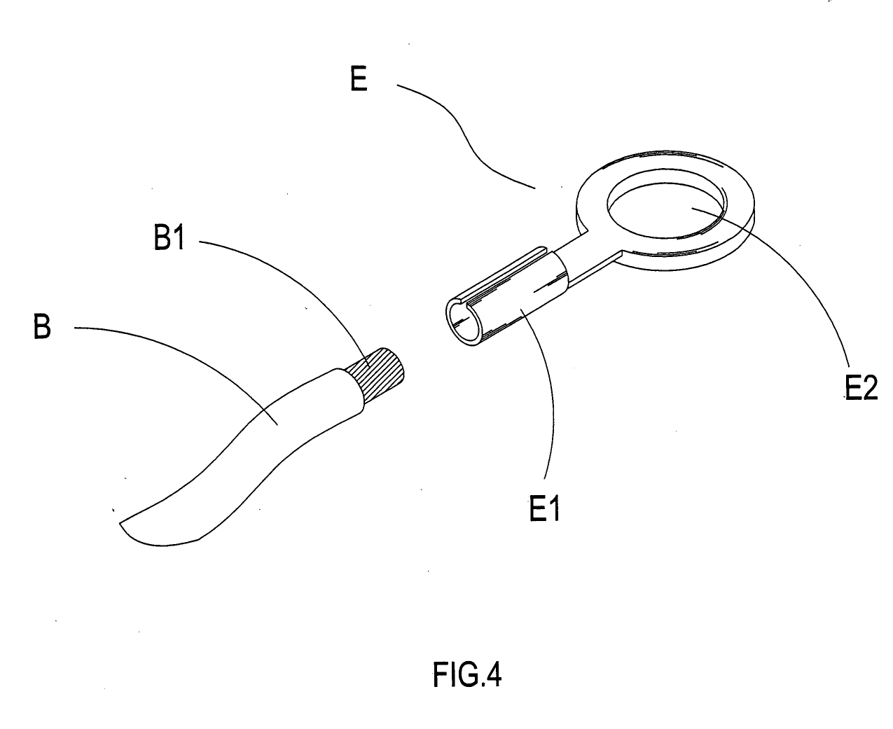

Referring to FIG. 3 and FIG. 4, a connector E according to the invention comprises a containing space E2 formed extendedly on one side of the connector E and a plurality of pressing pieces E1 configured extendedly on the other side. The pressing piece E1 is pressed with an inner wire B1 of a conducting wire B to join a conducting wire B and the connector E so as to provide the electrical conduction therebetween.

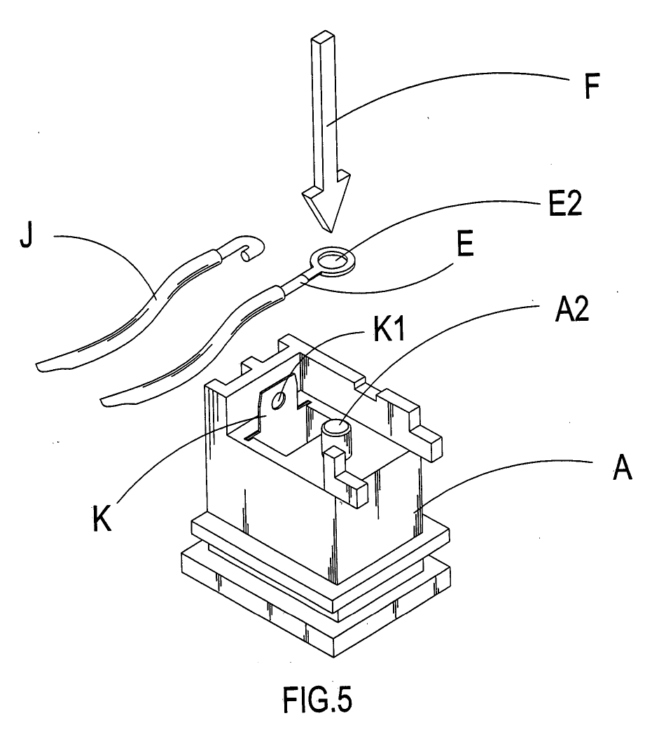

As shown in FIG. 4 and FIG. 5, a containing space E2 of a connector E is accommodated around a protruding part A2 of a base A to form a welded substance G between the connector E and the protruding part A2 by welding. A curved inner wire of a conducting wire J is fastened on a hole K1 of a metal terminal K on one side of the base A to form another welded substance G by welding so as to achieve electrical conduction.

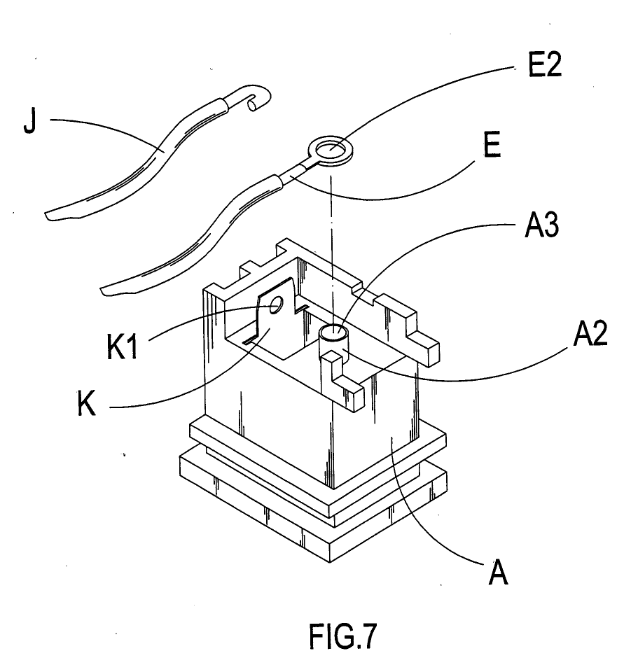

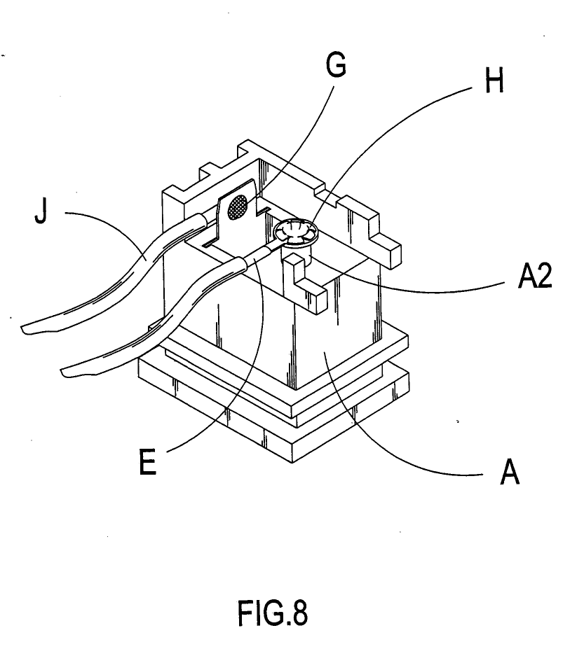

According to FIG. 7 and FIG. 8, a containing space E2 of a connector E is accommodated around a protruding pillar A2 with an aperture A3 configured thereon on one side of a base A to form an extruded part H around the protruding pillar A2 by riveting to join the connector E and the protruding pillar A2. A curved inner wire of a conducting wire J is fastened on a hole K1 configured on a metal terminal K on another side of the base A to form a welded portion G by welding to provide the joining effect.

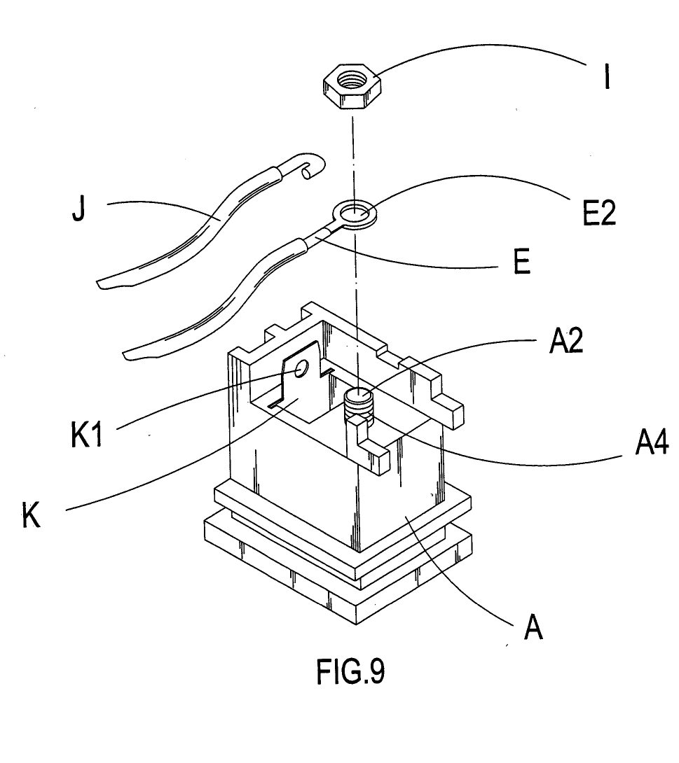

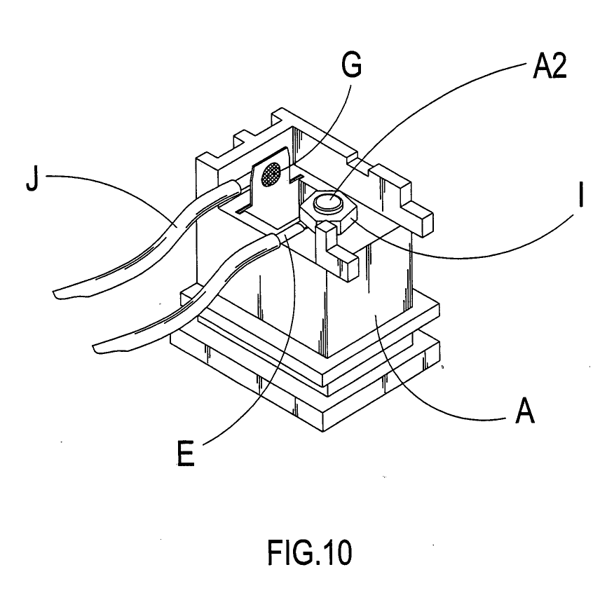

Furthermore, referring to FIG. 9 and FIG. 10, a thread of a screw A4 is configured externally on a protruding pillar A2 on one side of a base A. When a containing space E2 of a connector E is accommodated around the protruding pillar A2, the connector E and the protruding pillar A2 are joined by screwing a bolt I onto the protruding pillar A2. A curved inner wire of a conducting wire J is fastened on a hole K1 on a metal terminal K configured on another side of the base A to form a welded portion G therebetween to provide the connecting effect.

To emphasize novelty and practicability of the invention, the prior art and the invention are analyzed as below:

Drawbacks of the prior art:
1. The connector becomes loose and falls off easily after joining.
2. The joined parts using the prior joining method are insecure.
3. The connector falls off easily due to rising temperature during the operation.

Excellences of the invention:
1. Secured joined parts substantially reduce the possibilities of loosening and falling off.
2. The joining method is fast and easy.
3. The connector forms an integral structure after joining and is capable of preventing damages caused by external force.
4. The assembled connecting device increases efficiencies and provides industrial values.
5. The assembled connecting device increases industrial competitiveness.

It is of course to be understood that the embodiment described herein is merely illustrative of the principles of the invention and that a wide variety of modifications thereto may be effected by persons skilled in the art without departing from the spirit and scope of the invention as set forth in the following claims.

1-4. (canceled)

5. An assembly connecting device comprising:
a) a base having a protruding part; and
b) a connector having a containing space being a hollow opening located on a first end and a pressing piece located on a second end,
wherein the protruding part of the base is inserted through the containing space of the connector and electrically connected thereto,
wherein each of an exterior of the containing space, an interior of the containing space, and an exterior of the protruding part has a circular cross section.

6-7. (canceled)

8. The assembly connecting device according to claim 5, wherein the containing space and the protruding part are electrically connected by welding.

9. The assembly connecting device according to claim 5, wherein the containing space and the protruding part are electrically connected by riveting.

10. The assembly connecting device according to claim 5, further comprising a bolt threadedly connected to the protruding part and securing the containing space to the protruding part.
